(19) United States
(12) Patent Application Publication
(10) Pub. No.: US 2005/0135981 A1
(43) Pub. Date: Jun. 23, 2005

(54) Method and apparatus for reducing NOx and other vapor phase contaminants from a gas stream

(76) Inventor: Ramsay Chang, Los Altos, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/742,248

(22) Filed: Dec. 19, 2003

(51) Int. Cl. B01D 53/56

(52) U.S. Cl. 423/239.1; 422/177; 422/172; 422/171

(57) ABSTRACT

The present invention provides a method and apparatus for reducing the concentration of NOₓ in a gas stream. In one embodiment, the method comprises injecting a reducing agent to a gas stream comprising NOₓ; injecting a NOₓ-reducing catalyst into the gas stream; chemically reducing at least a portion of the NOₓ using said reducing agent and the NOₓ-reducing catalyst, thereby producing nitrogen and spent NOₓ-reducing catalyst; and removing the spent NOₓ-reducing catalyst from the gas stream. The present invention also provides a method and apparatus for reducing the concentration of NOₓ and another vapor phase contaminant in a gas stream, wherein this additional contaminant is adsorbed by the NOₓ-reducing catalyst.

### BACKGROUND OF THE INVENTION

1. Field of the Invention

The present invention relates a method and apparatus for removing vapor phase contaminants from a gas stream. More particularly, the present invention relates to a method and apparatus from the removal of nitrogen oxides (NOₓ) and mercury from flue gases generated by a coal-fired boiler.

2. Description of Related Art

Reduction of NOₓ and mercury from fossil-fired power plants are important in light of the 1990 Clean Air Act Amendment (CAAA) on air toxics (Title III) and subsequent regulatory determinations by the U.S. Environmental Protection Agency. The 1990 CAAA require all coal-fired utility boilers over a certain size to reduce NOₓ by about 50%. In addition, it is possible that regulations affecting the emission of NOₓ will become more stringent in the future, and power plants will need to reduce emissions even further. Special attention has also been given to mercury (Hg) in terms of its environmental release and impacts, and the Environmental Protection Agency (EPA) has just published its proposal for controlling mercury emissions for power plants.

These reductions are driven by concerns about ambient ozone and fine particle levels (PM2.5), for which NOₓ is considered a primary contributor, and mercury accumulation in fish, which may impact human health. NOₓ is emitted when fossil fuels such as coal, natural gas, or oil are burned in air. NOₓ emissions have attracted increased attention in recent years as more is learned about their role in acid rain, smog, visibility impairment and global climate change.

Mercury is present in flue gas in very low concentrations (<1 ppb) and forms a number of volatile compounds that are difficult to remove. Specially designed and costly emissions-control systems are required to capture these trace amounts of volatile compounds effectively.

Various types of pollution control equipment are available to reduce the levels of gaseous pollutants or vapor phase contaminants from the flue gas before it reaches the exhaust stack. For example, among other methods, NOₓ is often removed by selective catalytic reduction (SCR). To remove the NOₓ, a nitrogenous compound, such as ammonia, is injected into the flue gas stream as a reducing agent upstream of a catalyst bed. The ammonia reacts with the NOₓ in the presence of a catalyst, such as a Vanadia-Titania catalyst, to form nitrogen and water, thereby reducing the NOₓ content of the flue gas. More specifically, the catalyst is placed in a flue gas at temperatures exceeding 650° F. as a honeycomb or plate type structure, which occupies significant space and increases operating costs due to the attendant pressure drop. The Vanadia-Titania NOₓ SCR catalyst itself, along with the honeycomb or plate type structure, is also expensive to implement. Therefore, a more cost-effective NOₓ reduction solution is desirable.

Several approaches have also been adopted for removing mercury from gas streams. These techniques include passing the gas stream through a fixed or fluidized sorbent bed or structure or using a wet scrubbing system. The most common methods are often called “fixed bed” techniques. Approaches using fixed bed technologies normally pass the mercury containing gas through a bed consisting of sorbent particles or various structures such as honeycombs, screens, and fibers coated with sorbents. Common sorbents include powder activated carbon. The carbon is injected into the gas downstream of the air preheater at temperatures under 400° F. in front of a particulate collection device, such as an electrostatic precipitator or baghouse. Further, the mercury driven off can be recovered or removed separately.

There are, however, several disadvantages of fixed bed systems. Gas streams such as those from power plant coal combustion contain significant fly ash that can plug the bed structures and, thus, the beds need to be removed frequently from operation for cleaning. Alternatively, these beds may be located downstream of a separate particulate collector (see, for example, U.S. Pat. No. 5,409,522, entitled “Mercury Removal Apparatus and Method,” which is incorporated herein by reference in its entirety). Particulate removal devices ensure that components of the flue gas such as fly ash are removed before the gas passes over the mercury removal device. The beds will also have to be taken off-line periodically for regeneration, thereby necessitating a second bed to remain on-line while the first one is regenerating. These beds also require significant space and are very difficult to retrofit into existing systems such as into the ductwork of power plants without major modifications.

In another process to remove mercury or other vapor phase contaminants in a flue gas stream, a carbonaceous starting material is injected into a gas duct upstream of a particulate collection device. The carbonaceous starting material is activated in-situ and adsorbs contaminants. The activated material having the adsorbed contaminants is then collected in a particulate collection device. Such a process is described in U.S. Pat. Nos. 6,451,094 and 6,558,454, both entitled “Method for Removal of Vapor Phase Contaminants From a Gas Stream by In-Situ Activation of Carbon-Based Sorbents,” which are both incorporated herein by reference in their entireties.

Moreover, there are commercially available processes and systems that can facilitate the reduction of NOₓ and mercury. For example, the use of a fixed carbon bed downstream of air pre-heaters for the adsorption of SOₓ and mercury followed by the reduction of NOₓ with ammonia may be used. However, such a process is relatively expensive and difficult to implement due to the large reactor sizes required.

In view of the foregoing, there exists a need for an improved method and apparatus for removing NOₓ and vapor phase contaminants such as mercury from a gas stream.

### SUMMARY OF THE INVENTION

The present invention provides a method and apparatus for reducing the concentration of NOₓ in a gas stream. In one embodiment, the method comprises injecting a reducing agent to a gas stream comprising NOₓ; injecting a NOₓ-reducing catalyst into the gas stream; chemically reducing at least a portion of the NOₓ using said reducing agent and the NOₓ-reducing catalyst, thereby producing nitrogen and spent NOₓ-reducing catalyst; and removing the spent NOₓ-reducing catalyst from the gas stream.

In another embodiment, the apparatus comprises a grinder for grinding a NOₓ-reducing catalyst to produce a ground NOₓ-reducing catalyst; an injector configured to receive the ground NOₓ-reducing catalyst and to inject a mixture of a reducing agent and the ground NOₓ-reducing catalyst into a gas duct; a particulate collection device configured to remove the ground NOₓ-reducing catalyst that is positioned along the gas duct downstream of the injector.

The present invention also provides a method and apparatus for reducing the concentration of NOₓ and another vapor phase contaminant in a gas stream. In one embodiment, the method comprises injecting a reducing agent into a gas stream comprising NOₓ and a second vapor phase contaminant; injecting a NOₓ-reducing catalyst into the gas stream; chemically reducing at least a portion of the NOₓ and adsorbing at least a portion of the second vapor phase contaminant onto the NOₓ-reducing catalyst, thereby producing spent NOₓ-reducing catalyst; and removing the NOₓ-reducing catalyst from the gas stream.

In another embodiment, the method comprises generating a gas stream from a boiler, wherein the gas stream comprises NOₓ and fly ash comprising carbon; injecting a reducing agent into the gas stream downstream of the boiler; chemically reducing at least a portion of the NOₓ using the reducing agent and the carbon, thereby producing nitrogen; and removing the fly ash from the gas stream.

In another embodiment, the present invention provides a method and apparatus for reducing ammonia in a flue gas derived from a coal-fired boiler, wherein ammonia is being injected into the coal-fired boiler to reduce NOₓ, comprising generating a gas stream from a coal-fired boiler into which ammonia has been injected, wherein the gas stream comprises NOₓ and ammonia; injecting a NOₓ-reducing catalyst into the gas stream downstream of the boiler; chemically reducing at least a portion of the NOₓ using the ammonia and the NOₓ-reducing catalyst, thereby reducing the concentration of the ammonia in the gas stream and producing nitrogen and spent NOₓ-reducing catalyst; and removing the spent NOₓ-reducing catalyst from the gas stream.

Instead of installing a fixed catalyst bed for removing NOₓ, which requires space-consuming and costly honeycombs or plate structures that product a significant pressure drop, the present invention avoids this by injecting a NOₓ-reducing catalyst such that it is suspended and carried by the gas stream. In addition, the NOₓ-reducing catalyst may be selected such that it is capable of adsorbing another vapor phase contaminant in the gas stream, thereby performing two functions.

### BRIEF DESCRIPTION OF THE DRAWINGS

FIG. 1 provides a schematic diagram of one embodiment of the present invention.

### DESCRIPTION OF THE PREFERRED EMBODIMENTS

Generally, the present invention provides a method and apparatus for reducing the concentration of a vapor phase contaminant in a gas stream. More specifically, the present invention provides a method and apparatus for reducing the concentration of NOₓ in a gas stream, such as a flue gas stream from a coal-fired power plant. In one embodiment, the present invention comprises injecting a NOₓ-reducing catalyst, for example, in a powder or flake form, and a reducing agent into a gas stream and reducing the NOₓ components to nitrogen. The catalyst is then collected in a downstream particulate collective device.

Further, the present invention provides a method and apparatus for lowering the concentration of NOₓ and a second vapor phase contaminant, such as a vaporous trace metal, for example, mercury, in a gas stream, such as a flue gas stream from a coal-fired power plant. In one embodiment, the present invention comprises injecting a NOₓ-reducing catalyst, for example, in a powder or flake form, and a reducing agent into a gas stream and reducing the NOₓ components to nitrogen. In this particular embodiment, however, the NOₓ-reducing catalyst performs two functions. First, the NOₓ-reducing catalyst acts to catalyze the chemical reduction of NOₓ to nitrogen. Second, the NOₓ-reducing catalyst adsorbs a second vapor phase contaminant. The NOₓ-reducing catalyst having the second vapor phase contaminant adsorbed thereon is then collected in a downstream particulate collective device, thereby effectively reducing the concentration of NOₓ and a second vapor phase contaminant.

The following text in connection with the Figure describes various embodiments of the present invention. The following description, however, is not intended to limit the scope of the present invention. It should be appreciated that where the same numbers are used in different Figures, these refer to the same element or structure.

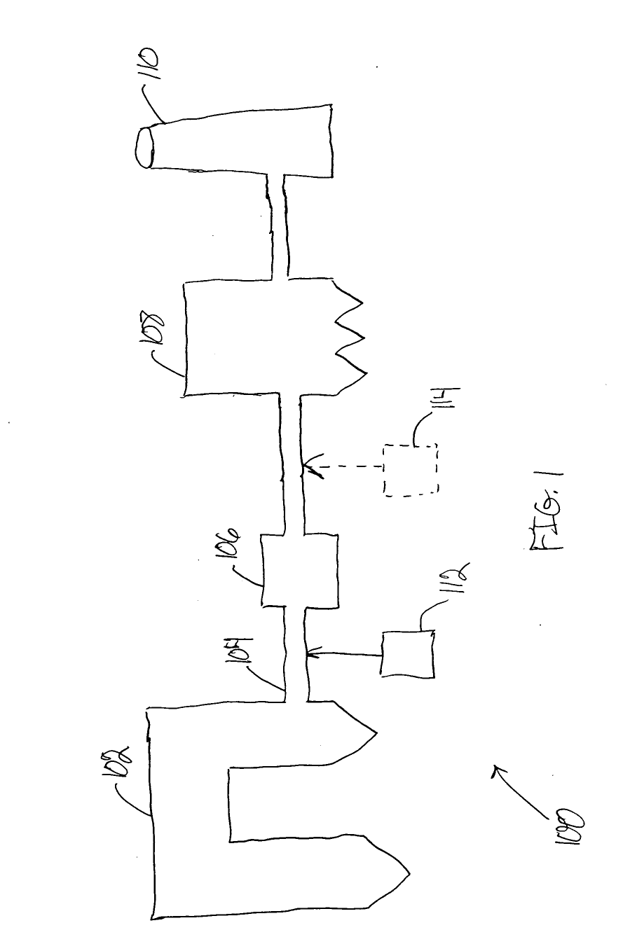

FIG. 1 is a schematic diagram of one embodiment of the present invention. The process 100 comprises a coal-fired boiler 102 that generates a flue gas that travels through a ductwork 104, through the air-preheater 106, through a particulate collection device 108, such as an electrostatic precipitator, a baghouse, a wet electrostatic precipitator or a combination thereof, and finally to a stack 110 where the flue gas is discharged to the atmosphere. The flue gas generated by the coal-fired boiler 102 comprises NOₓ and other vapor phase contaminants, such as vaporous heavy metals, for example, mercury.

To reduce the concentration of NOₓ, selective catalytic reduction is used. As in typical selective catalytic reduction, a reducing agent is injected into the flue gas duct upstream of the air-preheater 106 by an injector 112. It should be appreciated that the injector 112 that injects the reducing agent may be located at any point in the process, but is preferably upstream of the air-preheater 106. The reducing agent may be any chemical compound capable of chemically reducing NOₓ in the presence of a NOₓ-reducing catalyst. For example, the reducing agent may be ammonia.

Contrary to traditional selective catalytic reduction, which utilizes a fixed catalyst bed, the NOₓ-reducing catalyst in this embodiment is injected into the gas duct. The NOₓ-reducing catalyst may be prepared for injection by simply grinding the NOₓ-reducing catalyst to produce a ground NOₓ-reducing catalyst or a powdered NOₓ-reducing catalyst. Alternatively, the NOₓ-reducing catalyst may be in flake form, which facilitates suspension of the NOₓ-reducing catalyst in the gas stream once it is injected. In this case, the NOₓ-reducing catalyst may itself be made into a flake form or may be disposed on a flake-shaped support.

The injected NOₓ-reducing catalyst is suspended by and carried by the gas as it travels through the duct 104. It should be appreciated that the NOₓ-reducing catalyst may be injected using the same injector 112 that injects the reducing agent. In this case, the NOₓ-reducing catalyst may be injected concurrently with the reducing agent. It should further be appreciated that the NOₓ-reducing catalyst may be pre-treated with the reducing agent, such as by coating the NOₓ-reducing catalyst with the reducing agent.

It should also be appreciated that the NOₓ-reducing catalyst may be injected at a separate location from the injection of the reducing agent. For example, the NOₓ-reducing catalyst may be injected into the gas duct 104 downstream of the air-preheater 106 through the use of a second injector 114. In this case, the injector for injecting the NOₓ-reducing catalyst may be located at any position downstream of the air-preheater but upstream of the particulate collection device 108, which, as will be discussed below, acts to collect the injected NOₓ-reducing catalyst.

It is also possible to have multiple reducing agent and NOₓ-reducing catalyst injectors along the ductwork 104. By doing so, it is possible to create a more graduated reduction process by injecting smaller quantities of the reducing agent and catalyst from each injector. With multiple reducing agent and NOₓ-reducing catalyst injectors, different reducing agents and NOₓ-reducing catalysts may be injected into the ductwork by each injector. Regardless of the number of injectors actually used, both the reducing agent and NOₓ-reducing catalyst injectors should be located along the ductwork, prior to the flue gas entering the particulate collection device 110, such as electrostatic precipitators or baghouses, or a combination thereof, so that the reduction of NOₓ has fully occurred before the NOₓ-reducing catalysts are removed by the particulate control device 110. The location of the injectors can also vary along the ductwork, such as having injector ports aiming from the sides of the duct or the top or bottom of the duct.

Further, any means known by one skilled in the art can be used to inject the reducing agent and NOₓ-reducing catalyst into the duct 104. Both the reducing agent and NOₓ-reducing catalyst injectors should have some means to hold the reducing agent and NOₓ-reducing catalyst and some means to deliver these substances into the duct 104. For example, the reducing agent and NOₓ-reducing catalyst injectors may be any mechanical or pneumatic device, such as a pump or blower, that can be operated manually or by automatic control.

The NOₓ-reducing catalyst may be any catalyst capable of reducing NOₓ with the aid of a reducing agent. In one embodiment, the NOₓ-reducing catalyst may be a Vanadia-Titania catalyst. However, advantageously, the NOₓ-reducing catalyst may be selected such that it is capable of performing the additional function of adsorbing another or second vapor phase contaminant, such as mercury, onto its surface. In this case, the selection of the NOₓ-reducing catalyst requires that it be capable of both reducing NOₓ in the presence of a reducing agent and of adsorbing the desired vapor phase contaminant. In the case where the vapor phase contaminant desired to be adsorbed is mercury, the NOₓ-reducing catalyst may comprise a carbon-based material, such as activated carbon or high sodium char, since it has been shown that such a carbon-based material can both catalyze the chemical reducing of NOₓ as well as adsorb mercury or other vapor phase contaminants. It should be appreciated that depending upon the selection of the NOₓ-reducing catalyst and its adsorption properties relative to the vapor phase contaminants in the gas stream, more than one other vapor phase contaminant may be adsorbed.

Further, in systems where the fly ash has a sufficient level of carbon, due to, for example, incomplete combustion, this fly ash may itself may act as the NOₓ-reducing catalyst, as well as an adsorbent for another vapor phase contaminant. In this case, the reducing agent is still injected as described above, preferably downstream of the boiler 102 and upstream of the air-preheater 106; however, a separate NOₓ-reducing catalyst does not need to be injected. Alternatively, a separate NOₓ-reducing catalyst may be injected as described above.

Once both the reducing agent and the NOₓ-reducing catalyst have been injected into the gas stream, they are suspended and carried by the gas stream. As the gas stream travels, the chemical reduction of NOₓ occurs, thereby producing nitrogen, water and what is referred to herein as “spent” NOₓ-reducing catalyst. Additionally, if the NOₓ-reducing catalyst selected is capable of adsorbing another vapor phase contaminant, such adsorption also occurs. The spent NOₓ-reducing catalyst is then captured by the particulate collection device 108.

It should be appreciated that the spent NOₓ-reducing catalyst that is collected by the particulate collection device 108 may be regenerated. Before the spent catalyst can be regenerated, the spent catalyst must be collected, which is done by a particulate control device 110, such as, but not limited to, electrostatic precipitators, baghouses, wet electrostatic precipitators or a combination thereof. When spent catalyst is collected by the particulate control device 110, other particulates present in the gas stream are also collected, including fly ash. Therefore, spent catalyst is commingled with fly ash in the particulate control device 110. To facilitate easier and more effective separation of the collected particulates for spent catalyst regeneration, it is preferable to inject catalysts with geometries and/or physical characteristics that are different from fly ash.

In one preferred embodiment, the catalyst is ground into a predetermined size range that is different from that of the other particulate matter that is present in the flue gas and that will be collected concurrently with the spent catalyst. Any means known by one of skill in the art can be used to separate the particles, such as by using a sieve. In another embodiment, the catalyst may be shaped to allow it to be more easily separated from the fly ash. For example, using a flaked catalyst not only provides for ease of suspension upon injection into the gas stream, but also allows the flake-shaped catalyst to be more easily separated from the fly ash. This separation can be done by fluidizing the collected particulate matter, including fly ash and the spent, flake-shaped catalyst, whereby the spent catalyst can be more easily separated due to its flake shape providing more buoyancy than the remaining particulate matter. In another embodiment, the catalyst may be placed on a magnetic support. After the spent catalyst is collected by the particulate collection device, magnetic forces may be used to separate the spent catalyst on the magnetic support from the rest of the collected particulate matter. It should be appreciated that other physical characteristics may be exploited to facilitate separation of the spent catalyst from other collected particulate matter.

After the catalyst has been separated from the other collected particulate matter, such as fly ash, in the particulate control device, the spent catalyst can be recycled or regenerated for future use. As for regeneration of the spent catalyst, any means known in the art can be used. For example, the spent catalyst may be heated so that the mercury may be driven off the catalyst. After the spent catalyst has been regenerated, the catalyst may be recycled and injected back into the duct.

It should be appreciated that the present invention may be utilized in systems that already employ selective non-catalytic reduction for NOₓ. In these systems, ammonia is typically injected into the boiler where the higher temperatures are utilized to reduce the NOₓ components in the gas. However, unreacted ammonia is carried by the gas out of the boiler and through the downstream ductwork. This is referred to as ammonia slip. In these systems, a NOₓ-reducing catalyst may be injected downstream of the boiler, preferably upstream of the air-preheater, to take advantage of the ammonia present in the gas stream. The injected NOₓ-reducing catalyst in combination with the ammonia slip would chemically reduce any remaining NOₓ components in the gas, thereby reducing the amount of ammonia present in the gas. Further, the NOₓ-reducing catalyst may be selected to also adsorb another vapor phase contaminant as described above.

While the foregoing description and drawings represent various embodiments of the present invention, t should be appreciated that the foregoing description should not be deemed limiting since additions, variations, modification and substitutions may be made without departing from the spirit and scope of the present invention. It will be clear to one of skill in the art that the present invention may be embodied in other forms, structures, arrangements, proportions and using other elements, materials and components. For example, it is understood that although the invention has been described in the context of NOₓ and mercury removal, it should be appreciated that other gas phase contaminants may be removed using the same method and apparatus, except that an appropriate catalyst and/or reducing agent must be selected for the contaminant to be removed. Other examples also include adding other devices to the method and apparatus of the present invention to ensure lower levels of NOₓ and/or other vapor phase contaminants, such as mercury, in the gas stream exiting the stack 112. For example, a wet or dry scrubber downstream of the particulate control device may be used to absorb other vapor phase contaminants such as sulfur dioxides, oxidized mercury or other components. The present disclosed embodiments are, therefore, to be considered in all respects as illustrative and not restrictive, the scope of the invention being indicated by the appended claims and not limited to the foregoing description.

1. A method for reducing the concentration of NOₓ in a gas stream comprising:
injecting a reducing agent to a gas stream comprising NOₓ;
injecting a NOₓ-reducing catalyst into said gas stream;
chemically reducing at least a portion of said NOₓ using said reducing agent and said NOₓ-reducing catalyst, thereby producing nitrogen and spent NOₓ-reducing catalyst; and
removing said spent NOₓ-reducing catalyst from said gas stream.

2. The method of claim 1, wherein said reducing agent comprises ammonia.

3. The method of claim 1, further comprising grinding said NOₓ-reducing catalyst to produce a powdered NOₓ-reducing catalyst and wherein said injecting of said NOₓ-reducing catalyst comprises injecting said powdered NOₓ-reducing catalyst.

4. The method of claim 1, wherein said NOₓ reducing catalyst comprises Vanadia-Titania.

5. The method of claim 1, wherein said injecting said reducing agent comprises injecting said reducing agent into said gas stream at a first location along a gas path traveled by said gas stream and said injecting said NOₓ-reducing catalyst comprises injecting said NOₓ-reducing catalyst into said gas stream at said first location.

6. The method of claim 5, wherein said injecting said reducing agent and said injecting said NOₓ-reducing catalyst are performed concurrently.

7. The method of claim 6, further comprising coating said NOₓ-reducing catalyst with said reducing agent prior to said injecting of said reducing agent and said injecting of said NOₓ-reducing catalyst.

8. The method of claim 1, wherein said injecting said reducing agent comprises injecting said reducing agent into said gas stream at a first location along a gas path traveled by said gas stream and said injecting said NOₓ-reducing catalyst comprises injecting said NOₓ-reducing catalyst into said gas stream at a second location along said gas path.

9. The method of claim 8, wherein said second location is downstream of said first location.

10. The method of claim 1, further comprising regenerating said spent NOₓ-reducing catalyst.

11. The method of claim 10, wherein said regenerating comprises separating said spent NOₓ-reducing catalyst from fly ash that has been removed from said gas stream concurrently with said spent NOₓ-reducing catalyst.

12. The method of claim 11, wherein said fly ash has a first size range, and further comprising grinding a NOₓ-reducing catalyst to produce a ground NOₓ-reducing catalyst having a second size range that is different from said first size range of said fly ash, and wherein said separating comprises separating said spent NOₓ-reducing catalyst from said fly ash based upon the difference between said first size range and said second size range.

13. The method of claim 11, further comprising placing said NOₓ-reducing catalyst on a magnetic support prior to said injecting of said NOₓ-reducing catalyst, and wherein said separating comprises magnetically separating said spent NOₓ-reducing catalyst from said fly ash.

14. The method of claim 11, wherein said NOₓ-reducing catalyst comprises a shape that is different from the shape of said fly ash.

15. The method of claim 14, wherein said shape comprises a flake shape.

16. The method of claim 1, wherein said NOₓ-reducing catalyst comprises a carbon-based material.

17. The method of claim 16, wherein said gas stream further comprises mercury and further comprising adsorbing said mercury onto said carbon-based material.

18. The method of claim 17, wherein said injecting said reducing agent comprises injecting said reducing agent into said gas stream at a first location along a gas path traveled by said gas stream and said injecting said NOₓ-reducing catalyst comprises injecting said carbon-based material into said gas stream at said first location.

19. The method of claim 18, wherein said injecting said reducing agent and said injecting said carbon-based material are performed concurrently.

20. The method of claim 19, further comprising coating said carbon-based material with said reducing agent prior to said injecting of said reducing agent and said injecting of said carbon-based material.

21. The method of claim 17, wherein said injecting said reducing agent comprises injecting said reducing agent into said gas stream at a first location along a gas path traveled by said gas stream and said injecting said NOₓ-reducing catalyst comprises injecting said NOₓ-reducing catalyst into said gas stream at a second location along said gas path.

22. The method of claim 21, wherein said second location is downstream of said first location.

23. A method for reducing the concentration of NOₓ and a second vapor phase contaminant in a gas stream comprising:
injecting a reducing agent into a gas stream comprising NOₓ and a second vapor phase contaminant;
injecting a NOₓ-reducing catalyst into said gas stream;
chemically reducing at least a portion of said NOₓ and adsorbing at least a portion of said second vapor phase contaminant onto said NOₓ-reducing catalyst, thereby producing spent NOₓ-reducing catalyst; and
removing said NOₓ-reducing catalyst from said gas stream.

24. The method of claim 23, wherein said reducing agent comprises ammonia.

25. The method of claim 23, further comprising grinding said NOₓ-reducing catalyst to produce a powdered NOₓ-reducing catalyst and wherein said injecting of said NOₓ-reducing catalyst comprises injecting said powdered NOₓ-reducing catalyst.

26. The method of claim 23, wherein said injecting said reducing agent comprises injecting said reducing agent into said gas stream at a first location along a gas path traveled by said gas stream and said injecting said NOₓ-reducing catalyst comprises injecting said NOₓ-reducing catalyst into said gas stream at said first location.

27. The method of claim 26, wherein said injecting said reducing agent and said injecting said NOₓ-reducing catalyst are performed concurrently.

28. The method of claim 27, further comprising coating said NOₓ-reducing catalyst with said reducing agent prior to said injecting of said reducing agent and said injecting of said NOₓ-reducing catalyst.

29. The method of claim 23, wherein said injecting said reducing agent comprises injecting said reducing agent into said gas stream at a first location along a gas path traveled by said gas stream and said injecting said NOₓ-reducing catalyst comprises injecting said NOₓ-reducing catalyst into said gas stream at a second location along said gas path.

30. The method of claim 29, wherein said second location is downstream of said first location.

31. The method of claim 23, further comprising regenerating said spent NOₓ-reducing catalyst.

32. The method of claim 31, wherein said regenerating comprises separating said spent NOₓ-reducing catalyst from fly ash that has been removed from said gas stream concurrently with said spent NOₓ-reducing catalyst.

33. The method of claim 32, wherein said fly ash has a first size range, and further comprising grinding a NOₓ-reducing catalyst to produce a ground NOₓ-reducing catalyst having a second size range that is different from said first size range of said fly ash, and wherein said separating comprises separating said spent NOₓ-reducing catalyst from said fly ash based upon the difference between said first size range and said second size range.

34. The method of claim 32, further comprising placing said NOₓ-reducing catalyst on a magnetic support prior to said injecting of said NOₓ-reducing catalyst, and wherein said separating comprises magnetically separating said spent NOₓ-reducing catalyst from said fly ash.

35. The method of claim 32, wherein said NOₓ-reducing catalyst comprises a shape that is different from the shape of said fly ash.

36. The method of claim 35, wherein said shape comprises a flake shape.

37. The method of claim 23, wherein said NOₓ-reducing catalyst comprises a carbon-based material.

38. The method of claim 37, wherein said second vapor phase contaminant comprises mercury and further comprising adsorbing said mercury onto said carbon-based material.

39. The method of claim 38, wherein said injecting said reducing agent comprises injecting said reducing agent into said gas stream at a first location along a gas path traveled by said gas stream and said injecting said NOₓ-reducing catalyst comprises injecting said carbon-based material into said gas stream at said first location.

40. The method of claim 39, wherein said injecting said reducing agent and said injecting said carbon-based material are performed concurrently.

41. The method of claim 40, further comprising coating said carbon-based material with said reducing agent prior to said injecting of said reducing agent and said injecting of said carbon-based material.

42. The method of claim 38, wherein said injecting said reducing agent comprises injecting said reducing agent into said gas stream at a first location along a gas path traveled by said gas stream and said injecting said NOₓ-reducing catalyst comprises injecting said NOₓ-reducing catalyst into said gas stream at a second location along said gas path.

43. The method of claim 42, wherein said second location is downstream of said first location.

44. A method for reducing the concentration of NOₓ in a gas stream comprising:
generating a gas stream from a boiler, wherein said gas stream comprises NOₓ and fly ash comprising carbon;
injecting a reducing agent into said gas stream downstream of said boiler;
chemically reducing at least a portion of said NOₓ using said reducing agent and said carbon, thereby producing nitrogen; and
removing said fly ash from said gas stream.

45. The method of claim 44, wherein said gas stream further comprises mercury and further comprising adsorbing said mercury using said carbon in said fly ash.

46. The method of claim 45, wherein said injecting of said reducing agent comprises injecting said reducing agent upstream of an air-preheater.

47. A method for reducing ammonia in a flue gas derived from a coal-fired boiler, wherein ammonia is being injected into the coal-fired boiler to reduce NOₓ, comprising:
generating a gas stream from a coal-fired boiler into which ammonia has been injected, wherein said gas stream comprises NOₓ and ammonia;
injecting a NOₓ-reducing catalyst into said gas stream downstream of said boiler;
chemically reducing at least a portion of said NOₓ using said ammonia and said NOₓ-reducing catalyst, thereby reducing the concentration of the ammonia in said gas stream and producing nitrogen and spent NOₓ-reducing catalyst; and
removing said spent NOₓ-reducing catalyst from said gas stream.

48. The method of claim 47, wherein said gas stream further comprises mercury and further comprising adsorbing said mercury using said NOₓ-reducing catalyst.

49. The method of claim 48, wherein said injecting of said NOₓ-reducing catalyst comprises injecting said NOₓ-reducing catalyst upstream of an air-preheater.

50. An apparatus for removing NOₓ and vapor phase contaminants from a gas stream comprising:
a grinder for grinding a NOₓ-reducing catalyst to produce a ground NOₓ-reducing catalyst;
an injector configured to receive said ground NOₓ-reducing catalyst and to inject a mixture of a reducing agent and said ground NOₓ-reducing catalyst into a gas duct;
a particulate collection device configured to remove said ground NOₓ-reducing catalyst that is positioned along said gas duct downstream of said injector.

51. An apparatus for removing NOₓ and vapor phase contaminants from a gas stream comprising:
a means for passing a gas stream through a duct;
a means for injecting a reducing agent into said duct;
a means for injecting powdered material in said duct; and
a means for separating spent material from fly ash in said gas stream.

52. The apparatus of claim 51, further comprising a means for regenerating said spent material.

53. An apparatus for removing NOₓ and vapor phase contaminants from a gas stream comprising:
a gas duct;
a reducing agent injector configured to inject a reducing agent into said gas duct;
a catalyst injector configured to inject NOₓ-reducing catalyst into said gas duct; and
a particulate collection device connected to said gas duct and positioned downstream
of said reducing agent injector and said catalyst injector.
